(19) United States
(12) Patent Application Publication
(10) Pub. No.: US 2026/0165226 A1
(43) Pub. Date: Jun. 18, 2026

(54) Systems and Methods for Enhancing Ground Speed Determination for a Vehicle

(71) Applicant: Parker-Hannifin Corporation, Cleveland, OH (US)

(72) Inventors: Timothy A. Christensen, Mechanicsburg, IL (US); Daniel R. Van de Water, Morton, IL (US)

(21) Appl. No.: 19/127,183

(22) PCT Filed: Jan. 16, 2024
(86) PCT No.: PCT/US2024/011570

§ 371 Date: May 5, 2025

Related U.S. Application Data
(60) Provisional application No. 63/481,144, filed on Jan. 23, 2023.

(51) Int. Cl. A01B 79/00

(52) U.S. Cl. CPC A01B 79/005

(57) ABSTRACT

An example system includes: a ground speed sensor (102) mounted to a vehicle; and a controller performing operations comprising: identifying a reference vector (204) that is normal to a ground surface (106), causing the ground speed sensor to emit a plurality of beams (206,214) toward the ground surface, each beam of the plurality of beams being emitted at a known angle relative to the reference vector, for each beam of the plurality of beams, determining: (i) a respective measured speed based on the beam and a corresponding reflected beam, and (ii) a respective true ground speed based on the respective measured speed and the known angle, and determining, based on respective true ground speeds determined for the plurality of beams, a true ground speed of the vehicle.

### CROSS REFERENCE TO RELATED APPLICATION

The present application claims priority to U.S. Provisional Patent Application No. 63/481,144, filed on Jan. 23, 2023, the entire contents of which are herein incorporated by reference as if fully set forth in this description.

### TECHNICAL FIELD

The present invention relates generally to ground speed sensor systems for vehicles, and more particularly to a ground speed sensor system that enhances true ground speed determination for a vehicle regardless of a sensor mounting angle.

### BACKGROUND

True ground speed detection of a vehicle (e.g., tractor) used in agricultural and off-highway industries is important for precision planting, efficient chemical dispensing, optimized fertilizer spreading, etc. Current ground speed sensors are typically mounted on the vehicle pointed at an angle to the ground.

The ground speed sensor transmits a radar beam (wave) and receives a reflected beam (wave). The ground speed sensor uses electronic circuitry to mix the reflected signal with the transmit signal to produce a Doppler shift difference frequency. A measured ground speed is then calculated by measuring the change in frequency.

True ground speed is then calculated based on the mounting angle of the sensor and the measured ground speed. Such calculation assumes that the mounting angle is known accurately. However, the mounting angle might not be known accurately due so several factors such as wheel diameter, tread wear, and bolt hole tolerance, attachment loading changing, mounting margin, etc. These factors affect the mounting angle, and therefore increase error in determining true ground speed.

It may thus be desirable to have a ground speed system capable of determining true ground speed accurately regardless of the mounting angle of the sensor. It may also be desirable for the ground speed system to continually calibrate or compensate for other factors that change dynamically while operating, such as tire inflation, tread wear, etc. It is with respect to these and other considerations that the disclosure made herein is presented.

### SUMMARY

The present disclosure describes implementations that relate to systems and methods for enhancing ground speed determination for a vehicle.

In a first example implementation, this disclosure describes a system for determining true ground speed of a vehicle. The system includes: a ground speed sensor mounted to the vehicle and configured to emit a beam and receive a reflection of the beam from a ground surface; and a controller performing operations comprising: identifying a reference vector that is normal to the ground surface, wherein the reference vector represents a shortest distance from the ground speed sensor to the ground surface and is associated with a zero measured speed, causing the ground speed sensor to emit a plurality of beams toward the ground surface, each beam of the plurality of beams being emitted at a known angle relative to the reference vector, for each beam of the plurality of beams, determining: (i) a respective measured speed based on the beam and a corresponding reflected beam, and (ii) a respective true ground speed based on the respective measured speed and the known angle, and determining, based on respective true ground speeds determined for the plurality of beams, a true ground speed of the vehicle.

In a second example implementation, this disclosure describes a method for determining the true ground speed using the system of the first example implementation.

In a third example implementation, this disclosure describes a vehicle. The vehicle includes the system of the first example implementation, implementing the method of the second example implementation, for example. In this example implementation, the ground speed sensor can be mounted to an underside structure of the vehicle.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a schematic representation of a vehicle with a ground speed sensor mounted thereto, according to an example implementation.

FIG. 2 illustrates a schematic view of a ground speed system for determining ground speed of a vehicle, according to an example implementation.

FIG. 3 illustrates a graph plotting vertical distance versus speed for multiple beams, according to an example implementation.

FIG. 4A illustrates a ground speed sensor mounted horizontally, according to an example implementation.

FIG. 4B illustrates a ground speed sensor mounted at a first angle, according to an example implementation.

FIG. 4C illustrates a ground speed sensor mounted at a second angle, according to an example implementation.

FIG. 5 illustrates is a block diagram of a vehicle having a system for determining true ground speed of the vehicle, according to an example implementation.

FIG. 6 illustrates is a block diagram of a controller, according to an example implementation.

FIG. 7 is a flowchart of a method for determining true ground speed of a vehicle, according to an example implementation.

### DETAILED DESCRIPTION

Within examples, disclosed herein are systems and methods for determining true ground speed of a vehicle. In contrast to conventional systems, the disclosed systems and methods do not rely on the mounting angle or orientation of the sensor on the vehicle. Rather, the disclosed system and methods involve determining a normal vector associated with a zero speed point directly beneath the sensor. The normal vector is used as a reference vector.

The sensor can then emit multiple beams in an area of interest. For each beam, the system can determine the angle from the reference normal vector, and therefore determine a respective true ground speed of the vehicle based on the angle and the frequency shift associated with such beam. The system can then determine a true ground speed based on the respective true ground speeds of the multiple beams. The system can continue to determine the normal vector (the reference vector) periodically or continually to calibrate for any changes during operation of the vehicle. With this configuration, the system can determine the true ground speed accurately without having to rely on a particular mounting angle of the sensor, and the system further compensates for any changes that occur during operation of the vehicle.

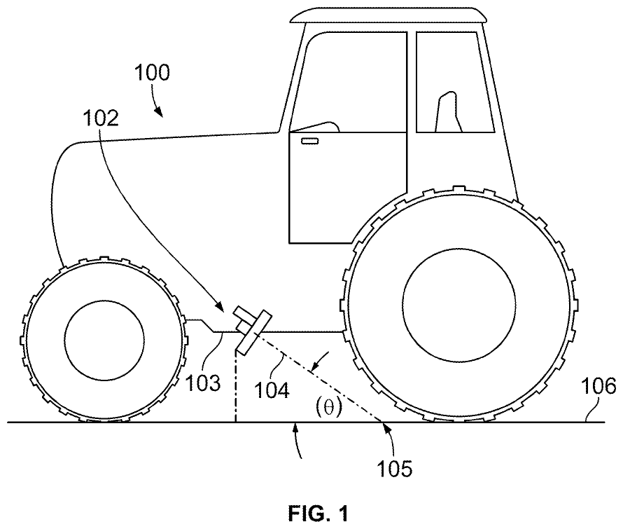

FIG. 1 illustrates a schematic representation of a vehicle 100 with a ground speed sensor 102 mounted thereto, according to an example implementation. The vehicle 100 can be a tractor used in agricultural or off-highway applications, for example. The vehicle 100 can have an implement configured to dispense a product (e.g., seeds), for example. It may be desirable to determine the speed of the vehicle accurately to control dispensation of such product in a controlled manner.

As shown, the ground speed sensor 102 is mounted to an underside structure 103 (e.g., chassis) of the vehicle 100 at a particular angle. The ground speed sensor 102 is configured to transmit a signal to emit a beam 104 (e.g., a radar beam or wave) to a target point 105 on a ground surface 106, and the beam 104 is reflected off of the ground surface 106 to form a reflected beam (radar beam or wave), which is then received by the ground speed sensor 102.

The ground speed sensor 102 can then use electronic circuitry to mix a received signal from the reflected radar beam with the transmit signal of the beam 104 to produce a Doppler shift difference frequency. A measured ground speed can then be calculated by measuring the change in frequency and the Doppler frequency shift.

Doppler effect principle entails the change in frequency of a wave in relation to an observer moving relative to the source of the wave. The ground speed sensor 102 measures the Doppler shift of the reflected radar beam, which is proportional to the ground speed of the vehicle 100 (i.e., the speed of the vehicle 100 relative to the ground surface 106). Particularly, the amount of frequency shift is directly proportional to the ground speed.

The ground speed (relative to the vehicle 100) is thus calculated by using the Doppler shift. For example, the measured ground speed can be determined as

$${V}_{Measured} = \frac{{Cf}_{d}}{2 {f}_{0}} ,$$

where C is the speed of light, f₀ is the transceiver frequency (frequency of the beam 104 emitted by the ground speed sensor 102), and f_{d} is the Doppler shift frequency (f−f₀), where f is the frequency of the reflected beam received at the ground speed sensor 102.

The ground speed sensor 102 is pointed at an angle toward the ground surface 106, and thus the true ground speed can be determined as a cos θ vector component of V_{Measured}. Particularly, the true ground speed can be determined by dividing the V_{Measured} by cos θ as follows:

$${V}_{True} = \frac{{V}_{Measured}}{cos θ} ,$$

wherein the angle θ is the angle that the beam 104 makes with the ground surface 106 at the target point 105 as depicted in FIG. 1. Thus, if the angle θ is known accurately, the true ground speed can be determined accurately with a single beam (e.g., the beam 104).

Existing sensor systems attempt to set the angle θ by mounting the ground speed sensor 102 at a predetermined fixed angle, such that the angle θ is known (e.g., preset or predefined). For example, the ground speed sensor 102 can be mounted such that the angle θ is 35°. In such systems, the ground speed sensor 102 is to be mounted exactly at the predetermined fixed angle such that the true ground speed is determined accurately. The precision with which the true ground speed is determined depends on the mounting angle being fixed and known.

However, several factors may affect the mounting angle, and therefore affect the accuracy of the true ground speed V_{True} determined based on the measured speed V_{Measured} and the angle θ of the beam 104 to the ground surface 106. For example, the ground speed sensor 102 might not be precisely mounted at the desired angle during factory installation due to human error, manufacturing tolerances, etc. In other cases, the vehicle 100 might not be level during sensor mounting or installation of a sensor bracket. Other factors may include wheel diameter changes from air pressure variance, loading or change in loading (e.g., due to product dispensation) of the vehicle 100, which can cause tilt from front to rear, the ground surface 106 being not level or on the same parallel plane as the sensor mount, vehicle bounce from irregular ground surface, and/or vehicle sink from soft or muddy surfaces.

If the actual mounting angle causes the angle θ to be less than the preprogrammed angle, then the speed determined by the ground speed sensor 102 might be faster than the actual true ground speed of the vehicle 100. Conversely, if the angle θ is greater than the preprogrammed angle, then the speed determined by the ground speed sensor 102 might be less than the actual true ground speed of the vehicle 100. In the example where the angle θ is 35°, a difference of 1° in the mounting angle can cause greater than 1% error in the speed calculation. This error might not be acceptable in some applications, and it may thus be desirable to configure a ground speed system that does not rely on the mounting angle of the ground speed sensor 102, and can also compensate for changes that occur during operation of the vehicle 100.

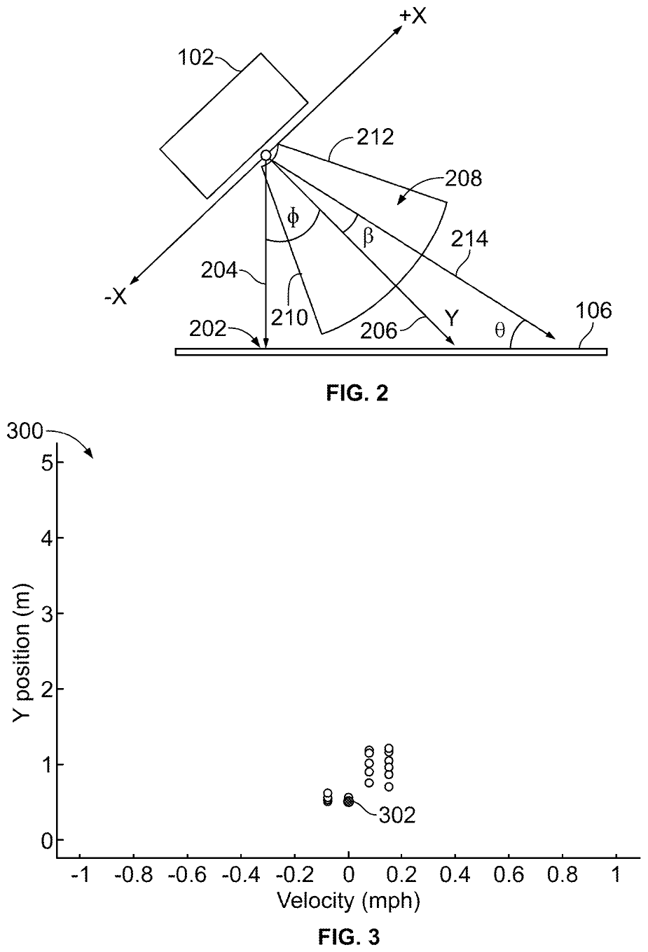

FIG. 2 illustrates a schematic view of a ground speed system for determining ground speed of the vehicle 100, according to an example implementation. Particularly, FIG. 2 illustrates a method for determining ground speed of the vehicle 100 using the ground speed sensor 102 without relying on an accurate mounting orientation or angle of the ground speed sensor 102.

The ground speed sensor 102 can be mounted at an angle as depicted. As such, the x-axis and the y-axis are defined from the frame of reference of the ground speed sensor 102 being tilted as shown in FIG. 2. The z-axis is perpendicular to the x-axis and the y-axis.

In an example, The ground speed sensor 102 can include a radar sensor, which may include one or more transmitters, one or more receivers, or one or more radar transceivers, to transmit and receive the radar signal. For instance, the ground speed sensor 102 can be configured as a radar transceiver (having an antenna, a transmitter, and a receiver) configured to emit radar beams (e.g., electromagnetic beam, such as microwave signal) at different angles.

For example, the ground speed sensor 102 can include a radar antenna that transmits the radar beam and receives the reflected radar beam, which is then processed by the electronic circuit or controller of the ground speed sensor 102. In one example, the radar signal is emitted in a beam pattern that is directed towards the ground surface 106, and the reflection from the ground surface 106 is collected by the antenna.

In an example, the antenna can be a directional antenna, which is configured to focus the emitted radar signal into a beam that is directed towards the ground surface 106 at a particular angle. The antenna can be a dish, a horn, or a phased array antenna. The transmitter is configured to generate the radar signal and amplify it before it is sent to the antenna. The transmitter can particularly generate a high-frequency signal, e.g., in the microwave range, that is modulated by a low-frequency signal to create the radar signal.

The receiver is configured to receive the reflected radar signal and amplify it before it is sent to the electronic circuit or controller (e.g., the controller 402 described below) for processing. In an example, the receiver uses a superheterodyne architecture. The superheterodyne receiver can down-convert the received high-frequency radar signal to a lower frequency that can be processed by the electronic circuit or controller.

The ground speed sensor 102 is configured to emit multiple beams at different angles, sequentially or substantially simultaneously. ground speed sensor 102 may dynamically adjust one or more of the beams through beam forming and/or adjustment in through the use of a phased array antenna. A phased array antenna may include multiple individual antenna elements that are controlled independently to create a beam that can be steered and focused. The individual antenna elements may be connected to a beam-forming network, which is responsible for controlling the phase and amplitude of the signal sent to each element. By adjusting the phase and amplitude of the signals sent to the individual elements, the beam-forming network can control the direction and shape of the radar beam emitted by the antenna. One or more of the radar beams can be steered by adjusting the phase of the signals sent to the individual elements, and the beam's shape can be adjusted by adjusting the amplitude of the signals. By combining these two adjustments, the beam-forming network can create a beam that is focused and directed towards the ground surface 106. The beam can also be adjusted to be wider or narrower, depending on the required measurement resolution. In examples, the ground speed sensor 102 can also use adaptive beamforming, where the beam-forming network is able to adapt the beam direction and shape in real-time, based on the received signals. This technique may improve the signal-to-noise ratio and reduce clutter, facilitating tracking multiple targets at once.

For each beam, the ground speed sensor 102 can then measure the ground speed of the vehicle 100 using Doppler frequency shift as described above. The ground speed sensor 102 can also measure the distance between the ground speed sensor 102 and the ground surface 106 by measuring the time delay between the transmission of the radar signal or beam and the receipt of the reflected signal/beam. Such distance represents the length of the beam, and varies depending on the angle of the beam to the ground surface 106.

Particularly, the ground speed sensor 102 can use radar time of flight to determine the distance to the ground surface 106. Time of flight can be described as a measurement of the time t taken by the beam emitted by the ground speed sensor 102 to travel to and from the ground surface 106. This information can then be used to measure a path length. For example, the distance d to the ground surface 106 can be calculated as

$$d = \frac{Ct}{2} ,$$

where C is the speed of light as mentioned above.

A first or initial operation performed by the ground speed sensor 102 (or a controller thereof) is to identify a reference vector that is normal to the ground surface 106 and represents the shortest distance from the ground speed sensor 102 to the ground surface 106 and represents a zero speed target point on the ground surface 106 (a point directly underneath the ground speed sensor 102). Particularly, the ground speed sensor 102 can emit beams at different angles (sweeping a range of angles in the x-axis direction and possibly the z-axis direction as well). For each beam, the ground speed sensor 102 receives a corresponding reflected beam and determines the distance to the ground surface 106 and a measured speed.

For a target point 202 directly underneath the ground speed sensor 102, a reference vector 204 represents the shortest distance from the ground speed sensor 102 to the ground surface 106. Further, because the reference vector 204 is normal to the ground surface 106, i.e., the angle therebetween is 90°, the measured speed is zero because V_{Measured}=Ground Speed×cos θ, where θ=90°, and cos(90) is zero. As such, the ground speed sensor 102 emits multiple beams to sweep an area on the ground surface 106 until it identifies the reference vector 204 having the shortest distance to the ground surface 106 and indicating a zero speed target (the target point 202).

FIG. 3 illustrates a graph 300 plotting vertical distance versus speed for the multiple beams, according to an example implementation. The y-axis of the graph 300 represents position or distance to the ground surface 106 in meters (m), and the x-axis of the graph 300 represents measured velocity/speed of a target point in miles per hour (mph). The points shown in the graph 300 represent the multiple beams emitted and received during the initial operation of identifying the reference vector 204.

As shown in the graph 300, point 302 represents the reference vector 204 as it represents the target point 202 with a zero speed and having the smallest or shortest distance to the ground surface 106. All the other points in the graph 300 either have a non-zero speed (and are thus located at an angle relative to the ground speed sensor 102, not directly underneath it) or has a distance larger than the distance to the target point 202 (which is located at the shortest distance from the ground speed sensor 102).

Referring back to FIG. 2, once the controller identifies the reference vector 204, the controller determines and stores an angle φ between the reference vector 204 and a y-axis vector 206 perpendicular to the ground speed sensor 102 and projecting from the ground speed sensor 102 to the ground surface 106. In the illustrated example, the angle φ is a negative angle (e.g., −45°) as the reference vector 204 is located in a clockwise direction relative to the y-axis vector 206.

The controller can then emit a plurality of beams at different angles from the reference vector 204, and determine the measured speed for each beam. In one example, the beams can be emitted sequentially, one beam at a time at a respective angle. In another example, the beams can be emitted at the same (substantially simultaneously) at the different respective angles.

In one example, the controller can determine an area of interest 208 bound or defined by a first boundary or first vector 210 located at a first threshold angle (e.g., 20 degrees) from the reference vector 204 and a second boundary or second vector 212 located at a second threshold angle (e.g., 55 degrees) from the reference vector 204. The controller can then cause the ground speed sensor 102 to sweep (emit a plurality of beams) in the area of interest 208 and determine the measured speed for each beam.

For example, the controller can cause the ground speed sensor 102 to emit a beam 214 at an angle within the area of interest 208. Particularly, the ground speed sensor 102 emits the beam 214 at a known angle β from the y-axis vector 206. The controller can thus determine the total known angle (β−φ) between the beam 214 and the reference vector 204. The angle φ is subtracted because it is a negative angle in this example as mentioned above, so the total angle would be β plus the absolute value of the angle φ. The controller can thus determine the angle θ between the beam 214 and the ground surface 106 as θ=90−(β−φ).

Further, the controller can determine a measured speed V_{Measured} using the Doppler shift principle as described above. Once the angle θ and V_{Measured} are known, the controller can determine the true ground speed V_{True} from the measured speed V_{Measured} as follows:

$${V}_{True} = \frac{{V}_{Measured}}{cos θ} .$$

As an example for illustration, if V_{Measured} is 3 mph, φ=−45°, β=15°, then the true ground speed V_{True} can be determined as

$$\frac{{V}_{Measured}}{cos ( 90 - ( β - φ ) )} = \frac{3}{cos ( 90 - ( 15 + 45 ) )} = 3.4 \; 641 mph .$$

This process can be repeated for each beam of the plurality of beams emitted by the ground speed sensor 102 (in the area of interest 208). The controller can then determine the true ground speed based on respective true ground speeds determined for the plurality of beams (including the beam 214). For example, the controller can average the respective true ground speeds.

Particularly, the controller can determine the average speed as follows:

$${V}_{True \_ avg} = \frac{{\sum }_{i = 1}^{n} {V}_{True \_ i}}{n} \qquad ( 1 )$$

where V_{True_avg} is the average true ground speed, n is the number of beams, and V_{True_i} is the true ground speed calculated for the individual beams.

Further, in some examples, the controller may implement a weighted average operation to reduce or eliminate the influence of some beams. Particularly, the controller can determine the average speed as follows:

$${V}_{True \_ avg} = \frac{{\sum }_{i = 1}^{n} {ω}_{i} {V}_{True \_ i}}{{\sum }_{i = 1}^{n} {ω}_{i}} \qquad ( 2 )$$

where ωᵢ are the weights assigned to each true ground speed V_{True_i}. As such, some of the true ground speeds associated with some of the beams can assigned small weights to reduce their influence. In some cases, the weight assigned to a particular beam can be set as zero to eliminate the influence of such beam on the speed determination.

In an example, the beams that form larger angles with the ground surface 106 may be assigned smaller weights compared to the beams that form shallower angles with the ground surface 106. This is due to the true ground speed being determined based on a cos (angle) factor of a measured speed. The larger the angle, the smaller the cosine of the angle, and vice versa. As such, the smaller the angle to the ground surface 106, the larger the magnitude of the measured speed.

Table 1 below shows an example comparison between averaging and weighted averaging. In this example, the ground speed is assumed to be 2 mph. The ground speed sensor 102 emits beams at different angles within an area of interest between 20° and 55°, each beam being incremented 5° from a previous beam. The angles of the beams are shown in the first column. Cosines of the angles (cos θ) are shown in the second column. The third column shows the measured speed (V_{Measured}), which results from the Doppler frequency shift described above. As demonstrated by Table 1, as the angle θ increases, the measured speed V_{Measured} gets smaller, which indicates that beams emitted at larger angles have less resolution compared to beams emitted at smaller angles.

To further demonstrate effect of averaging, a simulation of 1° error is placed on the angles. In other words, it is assumed that the angles that the controller uses have an error or offset of 1° from the actual angles. The percent change in V_{Measured} due to such error is shown in the fourth column. As shown, the error in V_{Measured} increases as the angle θ increases.

TABLE 1

| | | | % change | | | |
|---|---|---|---|---|---|---|
| | | | in | | | |
| | | | V_{Measured} | | | |
| | | | with 1° | | | Weights |
| Angle | cos | | angle | | | with |
| (θ) | θ | V_{Measured} | error | V_{Calculated} | Weight | Equation |
| 20 | 0.9397 | 1.8794 | 1.8672 | 1.9870 | 10 | 11.445 |
| 25 | 0.9063 | 1.8126 | 1.7976 | 1.9834 | 8 | 7.430 |
| 30 | 0.8660 | 1.7321 | 1.7143 | 1.9795 | 5 | 4.412 |
| 35 | 0.8192 | 1.6383 | 1.6180 | 1.9753 | 2 | 2.406 |
| 40 | 0.7660 | 1.5321 | 1.5094 | 1.9704 | 1 | 1.210 |
| 45 | 0.7071 | 1.4142 | 1.3893 | 1.9648 | 0.5 | 0.564 |
| 50 | 0.6428 | 1.2856 | 1.2586 | 1.9581 | 0.25 | 0.246 |
| 55 | 0.5736 | 1.1472 | 1.1184 | 1.9498 | 0.1 | 0.100 |

If simple averaging is implemented by equation (1) above where all the speeds in the fifth column (V_{Calculated}) have the weights and influence, the true ground speed is determined as 1.971 mph, which is 1.5% slower than the actual speed of 2 mph. By using weighting where a larger weight is assigned to beams with smaller angles, the error can be reduced.

Particularly, the sixth column shows example weights assigned to each beam based on the angle where beams with smaller angles are assigned larger weights, while beams with larger angles are assigned smaller weights. For instance, the speed for the beam having and angle of 25° is assigned a weight of 10, while the speed for the beam having and angle of 55° is assigned a weight of 0.1. Applying these weights using equation (2) and the speeds in the V_{Calculated} column, the resulting speed is 1.9822, which is only 0.89% slower than the actual speed, and represents an improvement over simple averaging.

In one example, the weights can be implemented as a look-up table in the controller of the ground speed sensor. The look-up table may have angles, band of angles, or fractions of angles and corresponding weights. In another example, rather than using a look-up table, an equation may be used to calculate the weight based on the angle θ. For instance, a plot may be generated between the angle θ and optimal weights, and then a trend line is fitting to the plot. An equation can then be determined for the trend line, and the controller can then determine the weight for any angle by using the equation. This way, the controller can determine the weight for any angle in a continuous range of angles as opposed to discrete angles.

As an example for illustration, the controller can determine that the trend line can be represented by the following equation: Weight=6·10⁻⁵*e^{(12.939 cos θ)}. These weights are shown in the last column in Table 1 above (right most column). Using these weights, the true ground speed can be calculated as 1.9823 mph.

Notably, determining the angle θ is not dependent on a preset mounting orientation of the ground speed sensor 102. Rather, the angle θ is calculated accurately using the process described above involving identifying the reference vector 204 and using known angles between the reference vector 204 and a particular emitted beam. Thus, regardless of any mounting inaccuracies of the ground speed sensor 102, the controller can determine the true ground speed accurately.

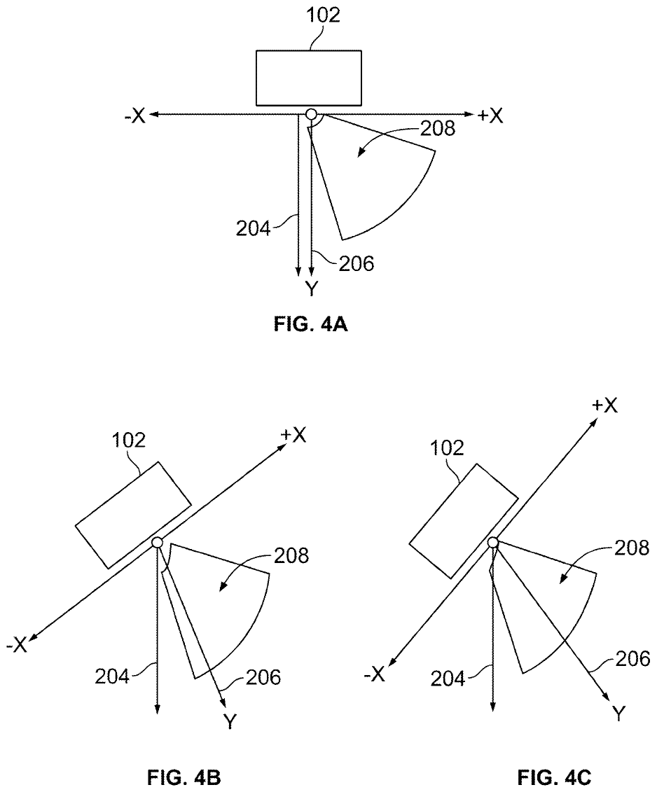

FIG. 4A illustrates the ground speed sensor 102 mounted horizontally, FIG. 4B illustrates the ground speed sensor 102 mounted at a first angle, and FIG. 4C illustrates the ground speed sensor 102 mounted at a second angle, according to an example implementation. As depicted schematically, regardless of the orientation of the ground speed sensor 102, the controller can implement the operations described above to determine the reference vector 204, its angle relative to the y-axis vector 206, and the area of interest 208 in some examples.

The controller then causes the ground speed sensor 102 to emit the plurality of beams in the area of interest 208, each beam emitted at a known angle relative to the reference vector 204, and thus its angle to the ground θ is determinable. Measured speed (determined via Doppler shift) and the known angles are then used to determine the true ground speed for each beam directed to a target point on the ground surface 106 and reflected therefrom. The controller then determines and outputs a true ground speed value based on the respective true ground speed values determined for the plurality of beams.

The process of identifying the reference vector 204 and the true ground speed can be continual or repeated periodically. This way, the controller can compensate for any changes that occur during operation of the vehicle 100.

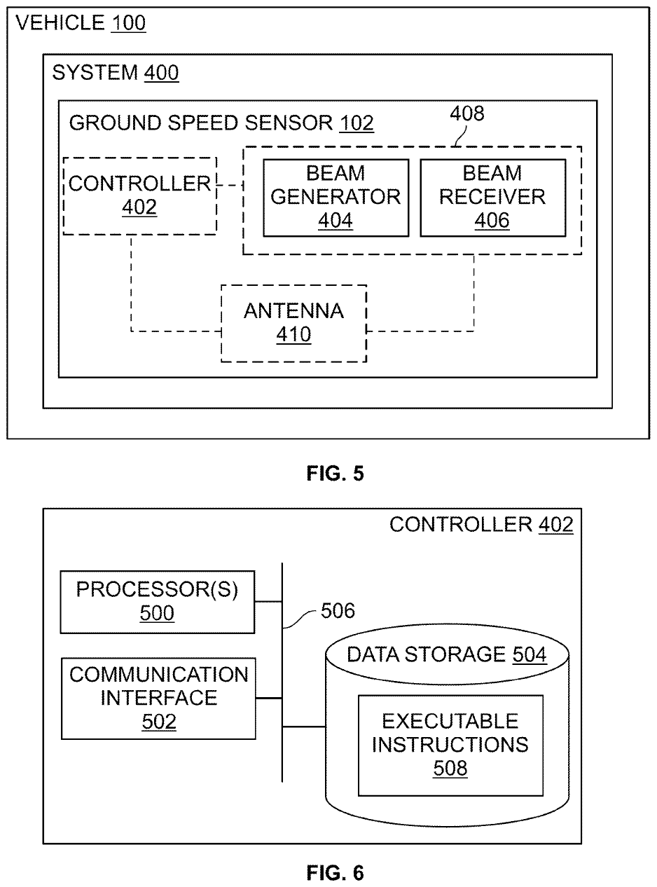

FIG. 5 is a block diagram of the vehicle 100 having a system 400 for determining true ground speed of the vehicle 100, according to an example implementation. The system 400 includes the ground speed sensor 102 described above.

The system 400 includes a controller 402. In an example, the controller 402 can be mounted in or is part of the ground speed sensor 102. In another example, the controller 402 can be separate from the ground speed sensor 102. For example, the controller 402 can be a controller of the vehicle 100. As such, the controller 402 is represented by a dashed block to indicate that it might not be included within the ground speed sensor 102. The controller 402 is configured to perform the operations described above to determine the true ground speed of the vehicle 100.

The ground speed sensor 102 includes a beam generator 404 (e.g., a source of beams or signals such as radar signals) and a beam receiver 406 configured to detect or receive beams reflected from the ground surface 106. As mentioned above, in an example, the ground speed sensor 102 can be or can include a radar sensor, wherein the beam generator 404 is a transmitter of radar signals and the beam receiver 406 is a receiver of the reflected radar signal. In some examples, the beam generator 404 and the beam receiver 406 can be augmented into a beam transceiver 408 configured to emit and receive signals/beams.

For instance, the beam transceiver 408 can be configured as a radar transceiver having an antenna 410 capable of emitting radar beams (e.g., electromagnetic beam, such as microwave signal) at different angles. The antenna 410 transmits the radar beam and receives the reflected radar beam, which is then processed by the controller 402 of the ground speed sensor 102.

The antenna 410 can be a directional antenna, which is configured to focus the emitted radar signal into a beam that is directed towards the ground surface 106 at a particular angle. The antenna can be a dish, a horn, or a phased array antenna. In this example, the beam generator 404 can be a transmitter configured to generate the radar signal and amplify it before it is sent to the antenna 410. The beam receiver 406 can be configured to receive the reflected radar signal and amplify it before it is sent to the controller 402 for processing.

FIG. 6 is a block diagram of the controller 402, according to an example implementation. The controller 402 may have processor(s) 500, a communication interface 502, and data storage 504, each connected to a communication bus 506. The controller 402 may also include hardware to enable communication within the controller 402 (e.g., via the communication bus 506), and communication between the controller 402 and a communication bus of the vehicle 100, for example. The hardware may include transmitters, receivers, and antennas, for example.

The communication interface 502 may be a wireless interface and/or one or more wireline interfaces that allow for both short-range communication and long-range communication to one or more networks or to one or more remote devices (e.g., to allow communication with a communication bus of the vehicle 100). Such wireless interfaces may provide for communication under one or more wireless communication protocols, Bluetooth, Wi-Fi (e.g., an institute of electrical and electronic engineers (IEEE) 402.11 protocol), Long-Term Evolution (LTE), cellular communications, near-field communication (NFC), and/or other wireless communication protocols. Wireline interfaces may include an Ethernet interface, a CAN network interface, a USB interface, or similar interface to communicate via a wire, a twisted pair of wires, a coaxial cable, an optical link, a fiber-optic link, or other physical connection to a wireline network.

Thus, the communication interface 502 may be configured to receive input data from the communication bus of the vehicle 100, and may be configured to send output data (e.g., true ground speed) to the communication bus. In that manner, the communication interface 502 or other communication ways may enable the controller 402 to receive information from the beam receiver 406 and send command signals to the beam generator 404 and/or the antenna 410 to emit beams at particular angles. The controller 402 can also output or broadcast via the communication interface 502 an indication of the true ground speed of the vehicle 100 for other components of the vehicle 100 to use it and perform other operations (e.g., control dispensation of a fertilizer), for example.

The data storage 504 may include or take the form of one or more computer-readable storage media that can be read or accessed by the processor(s) 500. The computer-readable storage media can include volatile and/or non-volatile storage components, such as optical, magnetic, organic or other memory or disc storage, which can be integrated in whole or in part with the processor(s) 500. The data storage 504 is considered non-transitory computer readable media. In some examples, the data storage 504 can be implemented using a single physical device (e.g., one optical, magnetic, organic or other memory or disc storage unit), while in other examples, the data storage 504 can be implemented using two or more physical devices.

The data storage 504 is a non-transitory computer readable storage medium, and executable instructions 508 are stored thereon. The executable instructions 508 include computer executable code. When the executable instructions 508 are executed by the processor(s) 500, the processor(s) 500 are caused to perform the operations of the controller 402 described herein.

The processor(s) 500 may be a general-purpose processor or a special purpose processor (e.g., digital signal processors, application-specific integrated circuits (ASIC), etc.). The processor(s) 500 may receive inputs from the communication interface 502, and process the inputs to generate outputs that are stored in the data storage 504. The processor(s) 500 can be configured to execute the executable instructions 508 (e.g., computer-readable program instructions) that are stored in the data storage 504 and are executable to provide the functionality of the controller 402 described herein.

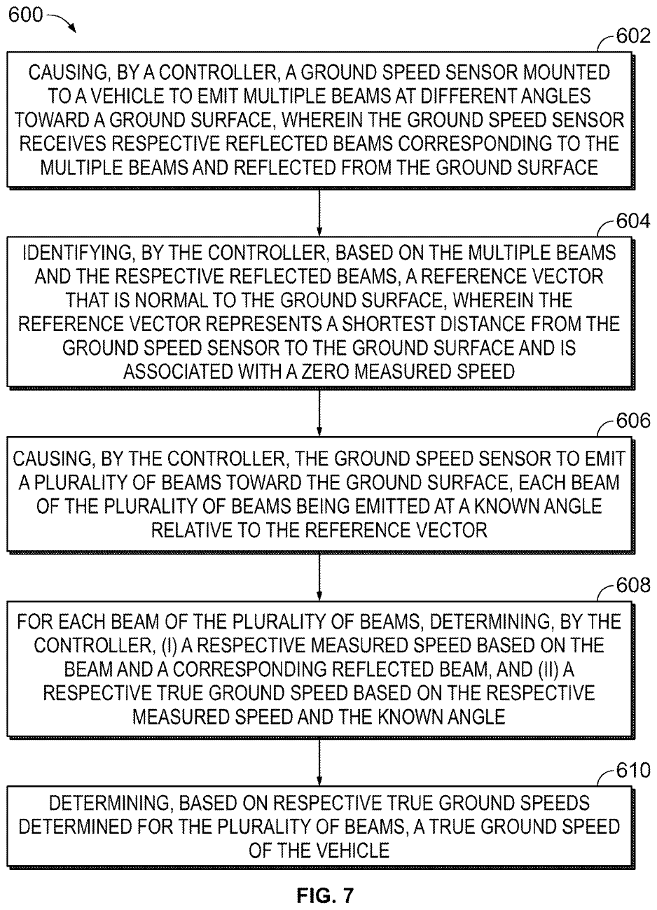

FIG. 7 is a flowchart of a method 600 for determining true ground speed of the vehicle 100, according to an example implementation. For example, the method 600 can be implemented by the controller 402.

The method 600 may include one or more operations, or actions as illustrated by one or more of blocks 602-610. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 600 and other processes and operations disclosed herein, the flowchart shows operation of one possible implementation of present examples. In this regard, each block may represent a module, a segment, or a portion of program code, which includes one or more instructions executable by a processor (e.g., the processor(s) 500 of the controller 402) or the controller 402 for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 600 and other processes and operations disclosed herein, one or more blocks in FIG. 7 may represent circuitry or digital logic that is arranged to perform the specific logical operations in the process.

At block 602, the method 600 includes causing, by the controller 402, the ground speed sensor 102 mounted to the vehicle 100 to emit multiple beams at different angles toward the ground surface 106, wherein the ground speed sensor 102 receives respective reflected beams corresponding to the multiple beams and reflected from the ground surface 106.

At block 604, the method 600 includes identifying, by the controller 402, based on the multiple beams and the respective reflected beams, the reference vector 204 that is normal to a ground surface, wherein the reference vector represents a shortest distance from the ground speed sensor 102 to the ground surface 106 and is associated with a zero measured speed.

At block 606, the method 600 includes causing, by the controller 402, the ground speed sensor 102 to emit a plurality of beams (e.g., the beam 214) toward the ground surface 106, each beam of the plurality of beams being emitted at a known angle (e.g., the sum of β and absolute value of φ in FIG. 2) relative to the reference vector 204.

At block 608, the method 600 includes, for each beam of the plurality of beams, determining, by the controller 402, (i) a respective measured speed V_{Measured} based on the beam and a corresponding reflected beam, and (ii) a respective true ground speed V_{True} based on the respective measured speed and the known angle

$${V}_{True} = \frac{{V}_{Measured}}{cos ( 90 - ( β - φ ) )} .$$

At block 610, the method 600 includes determining, based on respective true ground speeds determined for the plurality of beams, a true ground speed of the vehicle. This can be accomplished via averaging and/or other statistical techniques.

The method 600 can further include any of the steps described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a system for determining true ground speed of a vehicle, the system comprising: a ground speed sensor mounted to the vehicle and configured to emit a beam and receive a reflection of the beam from a ground surface; and a controller performing operations comprising: identifying a reference vector that is normal to the ground surface, wherein the reference vector represents a shortest distance from the ground speed sensor to the ground surface and is associated with a zero measured speed, causing the ground speed sensor to emit a plurality of beams toward the ground surface, each beam of the plurality of beams being emitted at a known angle relative to the reference vector, for each beam of the plurality of beams, determining: (i) a respective measured speed based on the beam and a corresponding reflected beam, and (ii) a respective true ground speed based on the respective measured speed and the known angle, and determining, based on respective true ground speeds determined for the plurality of beams, a true ground speed of the vehicle.

EEE 2 is the system of EEE 1, wherein identifying the reference vector comprises: causing the ground speed sensor to emit multiple beams at different angles toward the ground surface, wherein the ground speed sensor receives respective reflected beams corresponding to the multiple beams and reflected from the ground surface; and determining, based on the multiple beams and the respective reflected beams, a respective measured speed for each beam of the multiple beams, wherein the reference vector is associated with a beam of the multiple beams that has the shortest distance to the ground surface and associated with a target point on the ground surface having the zero measured speed.

EEE 3 is the system of any of EEEs 1-2, wherein the operations further comprise: determining an area of interest defined between a first threshold angle from the reference vector and a second threshold angle from the reference vector, wherein causing the ground speed sensor to emit the plurality of beams toward the ground surface comprises: causing the ground speed sensor to emit the plurality of beams within the area of interest.

EEE 4 is the system of any of EEEs 1-3, wherein determining the respective true ground speed based on the respective measured speed and the known angle comprises: determining, based on the known angle, an angle between the beam and the ground surface, wherein the respective true ground speed is determined based on the respective measured speed and the angle between the beam and the ground surface.

EEE 5 is the system of any of EEEs 1-4, wherein determining the true ground speed of the vehicle comprises: averaging the respective true ground speeds determined for the plurality of beams.

EEE 6 is the system of any of EEEs 1-5, further comprising: determining an angle between the reference vector and an axis perpendicular to the ground speed sensor and projecting from the ground speed sensor to the ground surface, wherein the known angle is determined based on the angle between the reference vector and the axis and a respective angle between the beam and the axis.

EEE 7 is the system of any of EEEs 1-6, wherein the beam is a radar beam emitted by an antenna of the ground speed sensor.

EEE 8 is the system of any of EEEs 1-7, wherein determining the respective measured speed comprises: determining the respective measured speed based on a Doppler frequency shift between the beam and reflected beam.

EEE 9 is a method that include any of the operations of EEEs 1-8. For example, the method comprises: causing, by a controller, a ground speed sensor mounted to a vehicle to emit multiple beams at different angles toward a ground surface, wherein the ground speed sensor receives respective reflected beams corresponding to the multiple beams and reflected from the ground surface; identifying, by the controller, based on the multiple beams and the respective reflected beams, a reference vector that is normal to the ground surface, wherein the reference vector represents a shortest distance from the ground speed sensor to the ground surface and is associated with a zero measured speed; causing, by the controller, the ground speed sensor to emit a plurality of beams toward the ground surface, each beam of the plurality of beams being emitted at a known angle relative to the reference vector; for each beam of the plurality of beams, determining, by the controller, (i) a respective measured speed based on the beam and a corresponding reflected beam, and (ii) a respective true ground speed based on the respective measured speed and the known angle; and determining, based on respective true ground speeds determined for the plurality of beams, a true ground speed of the vehicle.

EEE 10 is the method of EEE 9, further comprising: determining an area of interest defined between a first threshold angle from the reference vector and a second threshold angle from the reference vector, wherein causing the ground speed sensor to emit the plurality of beams toward the ground surface comprises: causing the ground speed sensor to emit the plurality of beams within the area of interest.

EEE 11 is the method of any of EEEs 9-10, wherein determining the respective true ground speed based on the respective measured speed and the known angle comprises: determining, based on the known angle, an angle between the beam and the ground surface, wherein the respective true ground speed is determined based on the respective measured speed and the angle between the beam and the ground surface.

EEE 12 is the method of any of EEEs 9-11, wherein determining the true ground speed of the vehicle comprises: averaging the respective true ground speeds determined for the plurality of beams.

EEE 13 is the method of any of EEEs 9-12, further comprising: determining an angle between the reference vector and an axis perpendicular to the ground speed sensor and projecting from the ground speed sensor to the ground surface, wherein the known angle is determined based on the angle between the reference vector and the axis and a respective angle between the beam and the axis.

EEE 14 is the method of any of EEEs 9-13, wherein determining the respective measured speed comprises: determining the respective measured speed based on a Doppler frequency shift between the beam and reflected beam.

EEE 15 is a vehicle including the system of any of EEEs 1-8 and capable of implemented the method of any of EEEs 9-14. For example, the vehicle comprises: an underside structure; a ground speed sensor mounted to the underside structure, wherein the ground speed sensor is configured to emit a beam and receive a reflection of the beam from a ground surface on which the vehicle is driven; and a controller performing operations comprising: identifying a reference vector that is normal to the ground surface, wherein the reference vector represents a shortest distance from the ground speed sensor to the ground surface and is associated with a zero measured speed, causing the ground speed sensor to emit a plurality of beams toward the ground surface, each beam of the plurality of beams being emitted at a known angle relative to the reference vector, for each beam of the plurality of beams, determining: (i) a respective measured speed based on the beam and a corresponding reflected beam, and (ii) a respective true ground speed based on the respective measured speed and the known angle, and determining, based on respective true ground speeds determined for the plurality of beams, a true ground speed of the vehicle.

EEE 16 is the vehicle of EEE 15, wherein identifying the reference vector comprises: causing the ground speed sensor to emit multiple beams at different angles toward the ground surface, wherein the ground speed sensor receives respective reflected beams corresponding to the multiple beams and reflected from the ground surface; and determining, based on the multiple beams and the respective reflected beams, a respective measured speed for each beam of the multiple beams, wherein the reference vector is associated with a beam of the multiple beams that has the shortest distance to the ground surface and associated with a target point on the ground surface having the zero measured speed.

EEE 17 is the vehicle of any of EEEs 15-16, wherein the operations further comprise: determining an area of interest defined between a first threshold angle from the reference vector and a second threshold angle from the reference vector, wherein causing the ground speed sensor to emit the plurality of beams toward the ground surface comprises: causing the ground speed sensor to emit the plurality of beams within the area of interest.

EEE 18 is the vehicle of any of EEEs 15-17, wherein determining the respective true ground speed based on the respective measured speed and the known angle comprises: determining, based on the known angle, an angle between the beam and the ground surface, wherein the respective true ground speed is determined based on the respective measured speed and the angle between the beam and the ground surface.

EEE 19 is the vehicle of any of EEEs 15-18, wherein determining the true ground speed of the vehicle comprises averaging the respective true ground speeds determined for the plurality of beams, wherein the vehicle further comprises an implement configured to dispense a product, and wherein the operations further comprises: control dispensation of the product from the implement based on the true ground speed of the vehicle.

EEE 20 is the vehicle of any of EEEs 15-19, wherein determining the respective measured speed comprises: determining the respective measured speed based on a Doppler frequency shift between the beam and reflected beam.

What is claimed is:

1. A system for determining true ground speed of a vehicle, the system comprising:
a ground speed sensor mounted to the vehicle and configured to emit a beam and receive a reflection of the beam from a ground surface; and
a controller performing operations comprising:
identifying a reference vector that is normal to the ground surface, wherein the reference vector represents a shortest distance from the ground speed sensor to the ground surface and is associated with a zero measured speed,
causing the ground speed sensor to emit a plurality of beams toward the ground surface, each beam of the plurality of beams being emitted at a known angle relative to the reference vector,
for each beam of the plurality of beams, determining: (i) a respective measured speed based on the beam and a corresponding reflected beam, and (ii) a respective true ground speed based on the respective measured speed and the known angle, and
determining, based on respective true ground speeds determined for the plurality of beams, a true ground speed of the vehicle.

2. The system of claim 1, wherein identifying the reference vector comprises:
causing the ground speed sensor to emit multiple beams at different angles toward the ground surface, wherein the ground speed sensor receives respective reflected beams corresponding to the multiple beams and reflected from the ground surface; and
determining, based on the multiple beams and the respective reflected beams, a respective measured speed for each beam of the multiple beams, wherein the reference vector is associated with a beam of the multiple beams that has the shortest distance to the ground surface and associated with a target point on the ground surface having the zero measured speed.

3. The system of claim 1, wherein the operations further comprise:
determining an area of interest defined between a first threshold angle from the reference vector and a second threshold angle from the reference vector, wherein causing the ground speed sensor to emit the plurality of beams toward the ground surface comprises:
causing the ground speed sensor to emit the plurality of beams within the area of interest.

4. The system of claim 1, wherein determining the respective true ground speed based on the respective measured speed and the known angle comprises:
determining, based on the known angle, an angle between the beam and the ground surface, wherein the respective true ground speed is determined based on the respective measured speed and the angle between the beam and the ground surface.

5. The system of claim 1, wherein determining the true ground speed of the vehicle comprises:
averaging the respective true ground speeds determined for the plurality of beams.

6. The system of claim 1, wherein the operations further comprise:
determining an angle between the reference vector and an axis perpendicular to the ground speed sensor and projecting from the ground speed sensor to the ground surface, wherein the known angle is determined based on the angle between the reference vector and the axis and a respective angle between the beam and the axis.

7. The system of claim 1, wherein the beam is a radar beam emitted by an antenna of the ground speed sensor.

8. The system of claim 1, wherein determining the respective measured speed comprises:
determining the respective measured speed based on a Doppler frequency shift between the beam and reflected beam.

9. A method comprising:
causing, by a controller, a ground speed sensor mounted to a vehicle to emit multiple beams at different angles toward a ground surface, wherein the ground speed sensor receives respective reflected beams corresponding to the multiple beams and reflected from the ground surface;
identifying, by the controller, based on the multiple beams and the respective reflected beams, a reference vector that is normal to the ground surface, wherein the reference vector represents a shortest distance from the ground speed sensor to the ground surface and is associated with a zero measured speed;
causing, by the controller, the ground speed sensor to emit a plurality of beams toward the ground surface, each beam of the plurality of beams being emitted at a known angle relative to the reference vector;
for each beam of the plurality of beams, determining, by the controller, (i) a respective measured speed based on the beam and a corresponding reflected beam, and (ii) a respective true ground speed based on the respective measured speed and the known angle; and
determining, based on respective true ground speeds determined for the plurality of beams, a true ground speed of the vehicle.

10. The method of claim 9, further comprising:
determining an area of interest defined between a first threshold angle from the reference vector and a second threshold angle from the reference vector, wherein causing the ground speed sensor to emit the plurality of beams toward the ground surface comprises:
causing the ground speed sensor to emit the plurality of beams within the area of interest.

11. The method of claim 9, wherein determining the respective true ground speed based on the respective measured speed and the known angle comprises:
determining, based on the known angle, an angle between the beam and the ground surface, wherein the respective true ground speed is determined based on the respective measured speed and the angle between the beam and the ground surface.

12. The method of claim 9, wherein determining the true ground speed of the vehicle comprises:
averaging the respective true ground speeds determined for the plurality of beams.

13. The method of claim 9, further comprising:
determining an angle between the reference vector and an axis perpendicular to the ground speed sensor and projecting from the ground speed sensor to the ground surface, wherein the known angle is determined based on the angle between the reference vector and the axis and a respective angle between the beam and the axis.

14. The method of claim 9, wherein determining the respective measured speed comprises:
determining the respective measured speed based on a Doppler frequency shift between the beam and reflected beam.

15. A vehicle comprising:
an underside structure;
a ground speed sensor mounted to the underside structure, wherein the ground speed sensor is configured to emit a beam and receive a reflection of the beam from a ground surface on which the vehicle is driven; and
a controller performing operations comprising:
identifying a reference vector that is normal to the ground surface, wherein the reference vector represents a shortest distance from the ground speed sensor to the ground surface and is associated with a zero measured speed,
causing the ground speed sensor to emit a plurality of beams toward the ground surface, each beam of the plurality of beams being emitted at a known angle relative to the reference vector,
for each beam of the plurality of beams, determining: (i) a respective measured speed based on the beam and a corresponding reflected beam, and (ii) a respective true ground speed based on the respective measured speed and the known angle, and
determining, based on respective true ground speeds determined for the plurality of beams, a true ground speed of the vehicle.

16. The vehicle of claim 15, wherein identifying the reference vector comprises:
causing the ground speed sensor to emit multiple beams at different angles toward the ground surface, wherein the ground speed sensor receives respective reflected beams corresponding to the multiple beams and reflected from the ground surface; and
determining, based on the multiple beams and the respective reflected beams, a respective measured speed for each beam of the multiple beams, wherein the reference vector is associated with a beam of the multiple beams that has the shortest distance to the ground surface and associated with a target point on the ground surface having the zero measured speed.

17. The vehicle of claim 15, wherein the operations further comprise:
determining an area of interest defined between a first threshold angle from the reference vector and a second threshold angle from the reference vector, wherein causing the ground speed sensor to emit the plurality of beams toward the ground surface comprises:
causing the ground speed sensor to emit the plurality of beams within the area of interest.

18. The vehicle of claim 15, wherein determining the respective true ground speed based on the respective measured speed and the known angle comprises:
determining, based on the known angle, an angle between the beam and the ground surface, wherein the respective true ground speed is determined based on the respective measured speed and the angle between the beam and the ground surface.

19. The vehicle of claim 15, wherein determining the true ground speed of the vehicle comprises averaging the respective true ground speeds determined for the plurality of beams, wherein the vehicle further comprises an implement configured to dispense a product, and wherein the operations further comprises:
control dispensation of the product from the implement based on the true ground speed of the vehicle.

20. The vehicle of claim 15, wherein determining the respective measured speed comprises:
determining the respective measured speed based on a Doppler frequency shift between the beam and reflected beam.
